(19) United States
(12) Patent Application Publication
(10) Pub. No.: US 2004/0131737 A1
(43) Pub. Date: Jul. 8, 2004

(54) Method of decreasing acrylamide in food cooked under heat

(75) Inventors: Yoshio Tomoda, Tokyo (JP); Akihiro Hanaoka, Chiba-shi (JP); Toshitaka Yasuda, Kawasaki-shi (JP); Tomo Takayama, Tokyo (JP); Ado Hiwatashi, Kawasaki-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: TOYO SUISAN KAISHA, LTD., Tokyo (JP)

(21) Appl. No.: 10/742,666

(22) Filed: Dec. 18, 2003

(30) Foreign Application Priority Data
Dec. 26, 2002 (JP) 2002-376987
Jun. 10, 2003 (JP) 2003-165509
Nov. 14, 2003 (JP) 2003-385595

(51) Int. Cl. A23L 1/00

(52) U.S. Cl. 426/438

(57) ABSTRACT

A method of preparing food to be cooked under heat or food cooked under heat, which is capable of decreasing acrylamide contained in the food after the cooking, wherein the method comprises adding to the food at least one aldonic acid or a salt thereof. The aldonic acid or the salt thereof is preferably selected from the group consisting of gluconic acid, galactonic acid, mannonic acid, allonic acid, altronic acid, gulonic acid, idonic acid, talonic acid lyxonic acid, xylonic acid, arabinonic acid, ribonic acid threonic acid, erythronic acid and salts thereof.

### CROSS-REFERENCE TO RELATED APPLICATIONS

This application is based upon and claims the benefit of priority from the prior Japanese Patent Applications No. 2002-376987, filed Dec. 26, 2002; No. 2003-165509, filed Jun. 10, 2003; and No. 2003-385595, filed Nov. 14, 2003, the entire contents of all of which are incorporated herein by reference.

### BACKGROUND OF THE INVENTION

1. Field of the Invention

The present invention relates to methods of preparing food to be cooked under heat and food cooked under heat, capable of decreasing acrylamide. The present invention also relates to food to be cooked under heat and food cooked under heat with lowered acrylamide prepared by using such methods.

2. Description of the Related Art

Food can be modified by cooking under heat so as to facilitate the decomposition and absorption of proteins and carbohydrates contained in the food. There are various methods of cooking food by heating, such as boiling, steaming, baking, and frying, and the cooking method is selected appropriately in accordance with, for example, the components of the food and the taste.

In recent years, traces of components which were not detected in the past, included in the components contained in various substances, have come to be detected due to the progress of analysis equipment. For example, a Swedish researcher reports that traces of acrylamide are formed by the cooking under heat of a livestock feed, as disclosed in, for example, “Chemical Research in Toxicology 13”: pp. 517-522 (2000). Also, a British researcher reports that asparagine, which is the main amino acid of potato and cereals, is mainly involved in the formation of acrylamide, as reported in, for example, “Nature” 419, pp. 448-450 (2002).

### BRIEF SUMMARY OF THE INVENTION

The present inventors also considered that, since noodles, which are handled in their business, use cereals as the raw materials and are cooked under heat during the preparation process thereof, it may be possible for acrylamide to be formed in the noodles and have begun to conduct research into acrylamide formation.

The present inventors have surprisingly found that it is possible to prepare instant fried noodles having lowered acrylamide by adding a specific aldonic acid or a salt thereof to the noodles before the cooking under heat. It has also been found that it is possible to decrease acrylamide in cooked foods under heat at high temperatures, e.g., fried with oil or baked in an oven, such as potato chips and cookies, by adding the specific aldonic acid or a salt thereof to the raw materials before the cooking under heat.

That is, an object of the present invention is to provide a method of preparing food to be cooked under heat or food cooked under heat capable of decreasing acrylamide. The object was achieved by the flowing means.

(1) A method of preparing food to be cooked under heat or food cooked under heat, which is capable of decreasing acrylamide contained in the food after the cooking, wherein the method comprises adding to the food at least one aldonic acid or a salt thereof.

(2) The method of preparing food to be cooked under heat or food cooked under heat according to item (1), wherein the aldonic acid or the salt thereof is selected from the group consisting of gluconic acid, galactonic acid, mannonic acid, xylonic acid and salts thereof.

(3) The method of preparing food to be cooked under heat or food cooked under heat according to item (1) or (2), wherein the food contains a cereal flour and/or starch.

(4) The method of preparing food to be cooked under heat or food cooked under heat according to any one of items (1) to (3), wherein the temperature at which the food is to be cooked or cooked under heat is not lower than 120° C.

(5) The method of preparing food to be cooked under heat or food cooked under heat according to item (4), wherein the cooking under heat is carried out by frying, stir-frying or roasting.

(6) The method of preparing food to be cooked under heat or food cooked under heat according to any one of items (1) to (5), wherein the food is selected from the group consisting of noodles, tempura (Japanese deep-fried food), baked confectionery, fried confectionery, snacks and foods having wrapping sheet of dough made of a cereal flour or starch.

(7) The method of preparing food to be cooked under heat or food cooked under heat according to any one of items (1) to (6), wherein the food is to be cooked or cooked at a temperature for a period of time which permit the amount of acrylamide to be increased after the cooking under heat, compared with the amount of acrylamide contained in the food before the cooking under heat, in the case where the food to which the aldonic acid or the salt thereof is not added, is cooked under heat.

(8) The method of preparing food to be cooked under heat according to any one of items (1) to (7), wherein the method does not comprise final cooking of the food under heat for serving to eat to which the aldonic acid or the salt thereof is added, thereby to prepare semi-cooked food.

(9) The method of preparing food cooked under heat according to any one of items (1) to (7), wherein the method further comprises cooking the food under heat to which the aldonic acid or the salt thereof is added, thereby to prepare the food cooked under heat.

(10) Food before cooking under heat, which is prepared by the method defined in any of items (1) to (8), and which is capable of lowering acrylamide contained in the food after the cooking under heat.

(11) Food cooked under heat, which is prepared by the method defined in any of items (1) to (7) and (9) in which acrylamide was lowered.

Additional objects and advantages of the present invention will be set forth in the description which follows, and in part will be obvious from the description, or may be learned by practice of the present invention. The objects and advantages of the present invention may be realized and obtained by means of the instrumentalities and combinations particularly pointed out hereinafter.

### BRIEF DESCRIPTION OF THE DRAWINGS

The single FIGURE is a flowchart showing the outline of the model test for suppressing the acrylamide formation.

### DETAILED DESCRIPTION OF THE INVENTION

The preparation method of food to be cooked under heat or food cooked under heat of the present invention (hereinafter referred to as the method of the present invention) which permits lowering the acrylamide content, will now be described in detail. In the following description, the term “food cooked under heat” includes the food that is to be cooked under heat, i.e., the food before the cooking under heat, and the food cooked under heat unless otherwise specified.

One of the characteristic features of the method of the present invention for preparing the food cooked under heat is that aldonic acid or a salt thereof is added to the food.

The aldonic acid used in the present invention denotes a derivative of aldose, i.e., monosaccharide having an aldehyde group and 4 to 6 carbon atoms, the aldehyde group of which is converted into a carboxylic group. The aldonic acid used in the present invention is not particularly limited as far as the aldonic acid permits decreasing the amount of acrylamide contained in the food. Examples of the aldonic acid include aldonic acids having 6 carbon atoms such as gluconic acid, galactonic acid, mannonic acid, allonic acid, altronic acid, gulonic acid, idonic acid and talonic acid; aldonic acid having 5 carbon atoms such as lyxonic acid, xylonic acid, arabinonic acid, and ribonic acid; and aldonic acid having 4 carbon atoms such as threonic acid and erythronic acid.

The aldonic acid used in the present invention includes many isomers including a stereoisomer (D-isomer/L-isomer), a cyclic isomer and other isomers such as D-glucono-1,4-lactone (gluconic acid γ-lactone), D-glucono-1,5-lactone (gluconic acid δ-lactone), D-galactono-1,4-lactone (D-galactonic acid γ-lactone), L-galactono-1,4-lactone (L-galactonic acid γ-lactone), and L-mannono-1,4-lactone (L-mannoic acid γ-lactone). The term “aldonic acid” used herein includes all of these isomers.

The salt of aldonic acid used in the present invention includes salts of monovalent metals such as Na and K, and poly-valent metals such as Ca, Mg, Al, Fe (divalent and trivalent), Cu, Zn and Ba, though the salts are not limited to these.

It is desirable for the solubility in water of the aldonic acid or a salt thereof to be high in view of the effect of decreasing the amount of acrylamide contained in the food after the cooking under heat, though the solubility noted above is not particularly limited as far as the amount of acrylamide contained in the food is decreased after the cooking under heat. The solubility, although it differs depending on, for example, the kind of the aldonic acid or the salt thereof, of at least 10 mg/100 g (25° C.), is preferable in view of the convenience.

The aldonic acid or the salt thereof is added to food. So, it is important that the compound may be used as an additive of the food, although it is needless to say that the compound to exhibit a high capability of decreasing the amount of acrylamide. Also, it is important that the compound is select from the view point of the solubility in water, color, taste, odor, cost and etc, depending on the food to which the compound is added.

In the method of the present invention, the amount of the aldonic acid or the salt thereof is not particularly limited as far as the amount of acrylamide contained in the food cooked under heat, to which the aldonic acid or the salt thereof is added, is lowered compared with the case where the aldonic acid or the salt thereof is not added. The amount may be decided appropriately depending on the kind of the food to which the compound is added, the heating temperature and the heating time, and the kind, the solubility in water and the ability of decreasing the amount of acrylamide of the used aldonic acid or the salt thereof. In view of the effect of decreasing acrylamide of the food after cooking under heat, it is desirable for the aldonic acid or the salt thereof to be used in a large amount. However, where the aldonic acid or the salt thereof itself has a taste and/or a color, it is desirable to determine the amount of the compound in view of, for example, the balance with the capability of maintaining the quality as the food. It is practical to use the aldonic acid or the salt thereof in an amount of 0.01 to 5% by weight based on the amount of the raw material.

However, depending on the food to which the method of the present invention is applied, there are cases where aldonic acid or the salt thereof used in the present invention and/or where the compound that can be converted into the aldonic acid or the salt thereof used in the present invention as a result of the reaction with, for example, water, are originally contained in the food to which the aldonic acid or the salt thereof is added. Further, there is a case where the aldonic acid or the salt thereof of the present invention is formed within the food during the cooking process under heat. In such cases, the amount of the aldonic acid or the salt thereof added to the food or the raw materials thereof may be decreased by the amount corresponding to the amount of the aldonic acid or the salt thereof originally contained in the food or the raw materials thereof, or the amount of the aldonic acid or the salt thereof generated during the cooking process under heat.

The aldonic acid or the salt thereof can be used singly. Alternatively, a plurality of the aldonic acid or the salt thereof can be used in combination. It is also possible to use the aldonic acid or the salt thereof in combination with the compound other than the aldonic acid or the salt thereof of the present invention.

In the present invention, the food with lowered acrylamide is achieved by using the aldonic acid or the salt thereof of the invention before cooking under heat. The food with lowered acrylamide denotes the food containing acrylamide lower than that of the same food, except that the additive is not added.

The food to which the method of the present invention can be applied is not particularly limited as far as, when the aldonic acid or the salt thereof is not used, acrylamide is generated by the cooking under heat. For example, the method of the present invention can be applied to the food containing cereal flours (such as wheat flour (e.g., strong flour, mellower strong flour, medium flour, soft flour and durum semolina), as well as buckwheat flour, rice powder), potatoes (e.g., white potatoes), and corn.

The particular foods cooked under heat include, for example, noodles (such as instant fried noodles, Yakisoba (stir-fried noodles or chow main), Ageyakisoba (fried and stir-fried noodles) and Yakiudon (stir-fried Japanese wheat noodle)), tempura (Japanese deep-fried food), baked confectionery (such as cookies, biscuits, crackers, and Mugikogashi (scorched wheat)), fried confectionery (such as doughnuts, Karintou (fried dough cake)), snacks (such as potato chips, fried potatoes (French frier), Imokempi (fried dough cake made of sweet potatoes), corn snacks, almonds, and bean snacks), Chinese foods having wrapping sheet of dough made of a cereal flour or starch (such as Agegyouza (fried dumpling stuffed with minced pork), Yakigyouza (pan-broiled dumpling stuffed with minced pork), Agesyumai (fried shao-mai), Yakisyumai (pan-broiled shao-mai), fried spring roll, and fried won-ton), Surimi-based products (such as Satsuma-age (fried fish cakes) and Chikuwa (fish paste)), teas (such as roasted tea, barley tea, coffee and cocoa), cereals, onion (such as a fried onion and roasted onion), and roasted sesame seeds, though the foods cooked under heat, to which the method of the present invention is applied, are not limited to these. Note that Ageyakisoba means hard-type Yakisoba, usually served to eat by sufficiently deep-frying Chinese noodle, which noodle may be raw, steamed or boiled, on which viscous sauce containing stir-fried ingredients, such as sea food, meat and vegetables, are poured, although Ageyakisoba is not limited to this.

Among the foods exemplified above, it is especially appropriate to apply the method of the present invention to, so-called “semi-cooked foods”, i.e., semi-cooked food before the final cooking under heat. Semi-cooked foods include food to which cutting and molding, etc., has been applied, as required, but cooking under heat has not yet been applied, and food to which cutting and molding, etc., has been applied, as required, and a preliminary cooking under heat has also been applied. These semi-cooked foods are subjected to heat treatment under temperatures not lower than 120° C. for preparation of the cooked food.

The semi-cooked foods include, for example, Yakisoba, which is before the final cooking of stir-frying, Yakigyouza, which is dumpling stuffed with minced pork before the final cooking, i.e., pan-broiling), potatoes for French frier, which are cut or molded after mashing, frozen pie dough, and frozen bread dough, though the semi-cooked foods to which the present invention is applied are not limited to these.

The food to which the method of the present invention is applied may be cooked in a conventional method, except that the aldonic acid or the salt thereof is added to the food before the cooking under heat.

In the method of the present invention, the method of adding the aldonic acid or the salt thereof to the food is not particularly limited. It is possible to select appropriately the method of adding the aldonic acid or the salt thereof in accordance with the state of the food to which the compound is added and in accordance with the preparation process. For example, where the food, to which the aldonic acid or the salt thereof is added, is a solid material like potatoes used for the preparation of potato chips, it is possible to use the compound as an aqueous solution, and the compound can be added to the food by means of coating, dipping or showering. On the other hand, where the food, to which the aldonic acid or the salt thereof is added, is a semi-solid material or a material having high fluidity such as a noodle dough or a dough for the baked confectionery, it is possible to knead an aqueous solution of the aldonic acid or the salt thereof into the dough or to apply the aqueous solution by means of the showering, spraying or coating. The number of adding operations is not particularly limited either. It is possible to add the aldonic acid or the salt thereof only once or in a plurality of times during the preparation process. Incidentally, where the aldonic acid or the salt thereof of the present invention is added by means of, for example, showering, spraying, or coating of an aqueous solution, the weights of the food before and after the application are measured and the addition amount is generally calculated from the difference in the measured weight between the food before and after the addition of the compound.

The timing at which the aldonic acid or the salt thereof is added to the food is not particularly limited as far as the compound is added before the cooking of the food under heat. It is possible to add the aldonic acid or the salt thereof at an appropriate timing during the cooking process of the food. When it comes to noodles, the aldonic acid or the salt thereof may be added during the kneading process of the noodle dough, or may be coated to noodles together with a seasoning component in the seasoning process. Also, when it comes to the baked confectionery such as cookies, the aldonic acid or the salt thereof may be added in the kneading process of the dough or may be coated during the molding process.

In the method of the present invention, it is possible to set the heating temperature and time for the heating at those applied in general to the food to which the present invention is applied. Needless to say, the method of the present invention is applied to the case where acrylamide is generated by cooking under heat that is carried out to the food. The temperature at which acrylamide is generated during the heating of the food is said to be relatively high, i.e., about 120° C. or higher. In the cooking of the food under heat, such a temperature condition arises, in general, during frying, which is generally carried out at 120 to 200° C., and during baking within an oven, which is generally carried out at 130 to 280° C., though the cooking process during which acrylamide generates is not limited to the frying and the baking pointed out above. It is known to the art that acrylamide formed under temperatures not lower than 180° C. is partly decomposed. It should be noted that the amount of acrylamide generated during the cooking is generally said to be increased with increase in the heating time.

The present invention also provides the food before the cooking under heat, which is prepared by the method of the present invention and which permits decreasing acrylamide, and the food after the cooking under heat, which has lowered acrylamide.

### EXAMPLES

Some Examples of the present invention will now be described, though the present invention is not limited to these Examples.

In the following Examples, the expression “%” denotes “% by weight”.

Comparative Example 1 described below and Examples 1 to 4 are the comparative example and the examples of the present invention in which the methods of the present invention are applied to fried noodles, respectively. The results are shown in Table 1 below.

### Comparative Example 1

Five kg of wheat flour, and 1.6 kg of water, to which 76 g of salt (sodium chloride) and 16.4 g of “kansui” were added and stirred, were charged to a mixer and kneaded for 18 minutes so as to obtain noodle dough. “Kansui” used in comparative examples and examples hereinafter contains potassium carbonate, sodium carbonate, and etc.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt (sodium chloride) and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 1

Five kg of wheat flour, and 1.6 kg of water, to which 76 g of salt (sodium chloride), 16.4 g of “kansui” and 19 g of calcium gluconate were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt (sodium chloride) and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 2

Five kg of wheat flour, and 1.6 kg of water, to which 76 g of salt (sodium chloride), 16.4 g of “kansui” and 50 g of ferrous gluconate were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt (sodium chloride), 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 3

Five kg of wheat flour, and 1.6 kg of water, to which 76 g of salt (sodium chloride), 16.4 g of “kansui” and 25 g of copper gluconate were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt (sodium chloride) and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 4

Five kg of wheat flour, and 1.6 kg of water, to which 76 g of salt (sodium chloride) and 16.4 g of “kansui” were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 5.02) containing 5.72% of salt (sodium chloride), 1.34% of sodium glutamate and 0.5% of a solution containing 50% gluconic acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

Comparative Example 2 described below and Example 5 are the comparative example and the example of the present invention in which the methods of the present invention are applied to another style of fried noodles, respectively. The results are shown in Table 2 below.

### Comparative Example 2

Five kg of wheat flour, and 1.6 kg of water, to which 76 g of salt (sodium chloride) and 30.0 g of phosphate, were charged to a mixer and kneaded for 18 minutes so as to obtain noodle dough.

The noodle dough thus obtained was stretched using rollers by the ordinary method so as to obtain a dough sheet having a thickness of 0.70 mm and, then, the dough sheet was cut by a square cutting roll No. 12 so as to obtain strands of the noodle having a width of 2.5 mm.

These strands of noodle were steamed for 90 seconds by the ordinary method, followed by spraying a seasoning solution (pH 6.80) containing 5.72% of salt (sodium chloride) and 1.34% of sodium glutamate.

Further, these strands of noodle were cut into a prescribed length and shaped into a molding block, followed by frying the cut strands of noodle at 15° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 5

Five kg of wheat flour, and 1.6 kg of water, to which 76 g of salt (sodium chloride) and 30.0 g of phosphate were added and stirred, were charged to a mixer and kneaded for 18 minutes so as to obtain noodle dough.

The noodle dough thus obtained was stretched using rollers by the ordinary method so as to obtain a dough sheet having a thickness of 0.70 mm and, then, the dough sheet was cut by a square cutting roll No. 12 so as to obtain strands of the noodle having a width of 2.5 mm.

These strands of noodle were steamed for 90 seconds by the ordinary method, followed by spraying a seasoning solution (pH 4.72) containing 5.72% of salt (sodium chloride), 1.34% of sodium glutamate and 1.0% of a solution containing 50% gluconic acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

Comparative Example 3 described below and Example 6 are the comparative example and the example of the present invention in which the methods of the present invention are applied to tempura or Kakiage (deep-fried mixture of ingredients such as vegetable, fish and etc.), respectively. The results are shown in Table 3 below.

### Comparative Example 3

Three hundred g of wheat flour, 6 g of salt (sodium chloride), 1.5 g of the whole egg powder and 1.2 g of a baking powder were added to 600 g of water, and stirred to prepare batter for Kakiage.

Then, a prescribed amount of the batter for Kakiage was fried at 170° C. for 3 minutes with palm oil thereby to obtain batter of Kakiage.

### Example 6

Three hundred g of wheat flour, 6 g of salt (sodium chloride), 1.5 g of the whole egg powder, 1.2 g of a baking powder and 3.0 g of a solution containing 50% gluconic acid were added to 600 g of water, and stirred to prepare batter for Kakiage.

Then, a prescribed amount of the batter for Kakiage was fried at 170° C. for 3 minutes with palm oil thereby to obtain batter for Kakiage.

Table 1 shows the blending conditions, the other preparation conditions, and the acrylamide content (ppb) of the fried noodles prepared in Comparative Example 1 and Examples 1 to 4 of the present invention. Table 2 shows the blending conditions, the other preparation conditions, and the acrylamide content (ppb) of the fried noodles prepared in Comparative Example 2 and Example 5 of the present invention. Further, Table 3 shows the blending conditions, the other preparation conditions, and the acrylamide content (ppb) of tempura (or Kakiage) prepared in Comparative Example 3 and Example 6 of the present invention.

The measuring method of acrylamide (AA) content of the fried noodles will be described herein later.

TABLE 1

| | Comp. 1 | | Inv. 1 | | Inv. 2 | | Inv. 3 | | Inv. 4 | |
|---|---|---|---|---|---|---|---|---|---|---|
| Blending | | | | | | | | | | |
| condition | | | | | | | | | | |
| <Main raw | | | | | | | | | | |
| material> | | | | | | | | | | |
| Wheat flour | 5.0 | kg | 5.0 | kg | 5.0 | kg | 5.0 | kg | 5.0 | kg |
| <Sub-raw | | | | | | | | | | |
| material> | | | | | | | | | | |
| Refined salt | 76 | g | 76 | g | 76 | g | 76 | g | 76 | g |
| (sodium | | | | | | | | | | |
| chloride) | | | | | | | | | | |
| “Kansui” | 16.4 | g | 16.4 | g | 16.4 | g | 16.4 | g | 16.4 | g |
| Calcium | — | | 19 | g | — | | — | | — | |
| gluconate | | | | | | | | | | |
| Ferrous | — | | — | | 50 | g | — | | — | |
| gluconate | | | | | | | | | | |
| Copper | — | | — | | — | | 25 | g | — | |
| gluconate | | | | | | | | | | |
| Water | 1.6 | kg | 1.6 | kg | 1.6 | kg | 1.6 | kg | 1.6 | kg |
| <Seasoning | | | | | | | | | | |
| component> | | | | | | | | | | |
| Refined salt | 57.2 | g | 57.2 | g | 57.2 | g | 57.2 | g | 57.2 | g |
| (sodium | | | | | | | | | | |
| chloride) | | | | | | | | | | |
| Sodium | 13.4 | g | 13.4 | g | 13.4 | g | 13.4 | g | 13.4 | g |
| glutamate | | | | | | | | | | |
| 50% | — | | — | | — | | — | | 5.0 | g |
| gluconic | | | | | | | | | | |
| acid | | | | | | | | | | |
| solution | | | | | | | | | | |
| Water | 1 | L | 1 | L | 1 | L | 1 | L | 1 | L |
| Analyzed | 100 | | 58 | | 47 | | 52 | | 69 | |
| AA value | | | | | | | | | | |
| (ppb) | | | | | | | | | | |

TABLE 2

| Blending condition | Comp. 2 | | Inv. 5 | |
|---|---|---|---|---|
| <Main raw material> | | | | |
| Wheat flour | 5.0 | kg | 5.0 | kg |
| <Sub-raw material> | | | | |
| Refined salt | 76 | g | 76 | g |
| (sodium chloride) | | | | |
| Phosphate | 30 | g | 30 | g |
| Water | 1.6 | kg | 1.6 | kg |
| <Seasoning component> | | | | |
| Refined salt | 57.2 | g | 57.2 | g |
| (sodium chloride) | | | | |
| Sodium glutamate | 13.4 | g | 13.4 | g |
| 50% Gluconic acid solution | — | | 10 | g |
| Water | 1 | L | 1 | L |
| Analyzed AA value (ppb) | 48 | | 35 | |

TABLE 3

| Blending condition | Comp. 3 | Inv. 6 |
|---|---|---|
| <Main raw material> | | |
| Wheat flour | 300 g | 300 g |
| <Sub-raw material> | | |
| Refined salt | 6 g | 6 g |
| (sodium chloride) | | |
| Whole egg powder | 1.5 g | 1.5 g |
| Baking powder | 1.2 g | 1.2 g |
| 50% gluconic acid solution | — | 3.0 g |
| Water | 600 g | 600 g |
| Analyzed AA value (ppb) | 106 | 99 |

As apparent from the results show in Tables 1 and 2, the addition of the aldonic acids or the salts thereof to the instant fried noodle allowed effective decrease in acrylamide contained therein. The addition method of the aldonic acids or the salts thereof may be either by way of kneading the compounds as a sub-raw material into the noodle dough or by way of adding the compounds into a seasoning solution and spraying the solution to the food.

Also, the results shown in Table 3 supports that the addition of the aldonic acids or the salts thereof to tempura (Kakiage) allowed effective decrease in acrylamide contained therein.

Comparative Example 4 and Examples 7 to 14 described below are a comparative example and examples of the present invention in which the methods of the present invention are applied to Ageyakisoba (fried and pan-broiled noodles), respectively. The results are shown herein later in Table 4.

### Comparative Example 4

Wheat flour in an amount of 2700 g, and 1020 g of water, to which 300 g of potato starch, 30 g of salt (sodium chloride) and 15 g of “kansui” were added and stirred, were charged to a mixer and kneaded for 10 minutes so as to obtain noodle dough.

The noodle dough thus obtained was stretched using rollers by the ordinary method so as to obtain a dough sheet having a thickness of 0.90 mm and, then, the dough sheet was cut by a square cutting roll No. 34 so as to obtain strands of the noodle having a width of 0.90 mm.

Further, these strands of noodle were cut into a prescribed length and shaped into a molding block, followed by frying the cut strands of noodle at 175° C. for 70 seconds with vegetable oil (80% of rape oil and 20% of palm oil), thereby obtaining Ageyakisoba. Then, the Ageyakisoba was wrapped in a shrink film and housed in an exclusive tray together with a soup, followed by wrapping the tray so as to prepare Ageyakisoba.

### Examples 7 to 14

Wheat flour in an amount of 2700 g, and 1020 g of is water, to which 300 g of potato starch, 30 g of salt (sodium chloride), 15 g of “kansui” and 15 g of each compound to be tested were added as shown in Table 4 and stirred, were charged to a mixer and kneaded for 10 minutes so as to obtain noodle dough.

The noodle dough thus obtained was stretched using rollers by the ordinary method so as to obtain a dough sheet having a thickness of 0.90 mm and, then, the dough sheet was cut by a square cutting roll No. 34 so as to obtain strands of the noodle having a width of 0.90 mm.

Further, these strands of noodle were cut into a prescribed length and shaped into a molding block, followed by frying the cut strands of noodle at 175° C. for 70 seconds with vegetable oil (80% of rape oil and 20% of palm oil), thereby obtaining several kinds of Ageyakisoba. Then, the Ageyakisoba were wrapped in a shrink film and housed in an exclusive tray together with a soup, followed by wrapping the tray so as to prepare Ageyakisoba.

Table 4 shows the blending conditions and the acrylamide content (ppb) of the noodles prepared in Comparative Example 4 and Examples 7 to 14 of the present invention.

TABLE 4

| | Comp. | | Inv. | | Inv. | | Inv. | | Inv. | |
|---|---|---|---|---|---|---|---|---|---|---|
| | 4 | | 7 | | 8 | | 9 | | 10 | |
| Blending | | | | | | | | | | |
| condition | | | | | | | | | | |
| <Main raw | | | | | | | | | | |
| material> | | | | | | | | | | |
| Wheat | 2700 | g | 2700 | g | 2700 | g | 2700 | g | 2700 | g |
| flour | | | | | | | | | | |
| White | 300 | g | 300 | g | 300 | g | 300 | g | 300 | g |
| potato | | | | | | | | | | |
| starch | | | | | | | | | | |
| <Sub-raw | | | | | | | | | | |
| material> | | | | | | | | | | |
| Refined salt | 30 | g | 30 | g | 30 | g | 30 | g | 30 | g |
| (sodium | | | | | | | | | | |
| chloride) | | | | | | | | | | |
| “Kansui” | 15 | g | 15 | g | 15 | g | 15 | g | 15 | g |
| 50% | — | | 30 | g | — | | — | | — | |
| Gluconic | | | | | | | | | | |
| acid | | | | | | | | | | |
| solution | | | | | | | | | | |
| Sodium | — | | — | | 15 | g | — | | — | |
| gluconate | | | | | | | | | | |
| Potassium | — | | — | | — | | 15 | g | — | |
| gluconate | | | | | | | | | | |
| Calcium | — | | — | | — | | — | | 15 | g |
| gluconate | | | | | | | | | | |
| Water | 1020 | g | 990 | g | 1020 | g | 1020 | g | 1020 | g |
| Analyzed | 523 | | 353 | | 433 | | 411 | | 405 | |
| AA | | | | | | | | | | |
| value | | | | | | | | | | |
| (ppb) | | | | | | | | | | |

| | Inv. 11 | | Inv. 12 | | Inv. 13 | | Inv. 14 | |
|---|---|---|---|---|---|---|---|---|
| Blending | | | | | | | | |
| condition | | | | | | | | |
| <Main raw | | | | | | | | |
| material> | | | | | | | | |
| Wheat flour | 2700 | g | 2700 | g | 2700 | g | 2700 | g |
| White potato | 300 | g | 300 | g | 300 | g | 300 | g |
| starch | | | | | | | | |
| <Sub-raw | | | | | | | | |
| material> | | | | | | | | |
| Refined salt | 30 | g | 30 | g | 30 | g | 30 | g |
| (sodium chloride) | | | | | | | | |
| “Kansui” | 15 | g | 15 | g | 15 | g | 15 | g |
| Ferrous | 15 | g | — | | — | | — | |
| gluconate | | | | | | | | |
| Copper | — | | 15 | g | — | | — | |
| gluconate | | | | | | | | |
| Zinc | — | | — | | 15 | g | — | |
| gluconate | | | | | | | | |
| D-Galactonic | — | | — | | — | | 15 | g |
| acid γ-lactone | | | | | | | | |
| Water | 990 | g | 1020 | g | 1020 | g | 1020 | g |
| Analyzed AA | 403 | | 408 | | 359 | | 361 | |
| value (ppb) | | | | | | | | |

As apparent from the results shown in Table 4, the addition of the aldonic acids or the salts thereof to Yakisoba allowed effective decrease in acrylamide contained therein. In other words, the use of these compounds provides methods of preparing Ageyakisoba with decreased acrylamide.

Comparative Example 5 and Examples 15 and 16 described below are a comparative example and examples of the present invention in which the methods of the present invention are applied to Agegyouza (pan-broiled dumping stuffed with minced pork). The results are shown herein later in Table 5.

### Comparative Example 5

Water in an amount of 340 g, to which 1000 g of wheat flour and 10 g of salt (sodium chloride) were added and stirred, were charged to a mixer and kneaded for 12 minutes so as to obtain dough for wrapping Gyouza (dumpling stuffed with minced pork).

The dough thus obtained was stretched using rollers by the ordinary method so as to obtain a dough sheet having a thickness of 0.70 mm and, then, the dough sheet was cut out using a molding die (80 mm×88 mm φ) so as to obtain wrapping sheet of Gyouza.

In the next step, the stuffing of the Gyouza was prepared by kneading a mixture consisting of 700 g of minced pork, 1000 g of cabbage cut into tiny pieces each having a width of 5 mm, 20 g of cut leek pieces each having a width of 5 mm, and seasonings consisting of 18 g of salt (sodium chloride), 2 g of pepper, 22 g of grated ginger, 14 g of grated garlic, 24 g of soy sauce, and 34 g of sesame oil. The mixture noted above was kneaded in a mixer for 5 minutes so as to obtain the stuffing of Gyouza.

The stuffing thus obtained was divided into small pieces each weighing 12.5 g, and each small piece was molded with the wrapping sheet mentioned above in a molding machine of Gyouza so as to obtain uncooked Gyouza. The uncooked pieces thus obtained were arrayed on an exclusive tray and steamed at 90° C. for 10 minutes, followed by cooling the steamed pieces of Gyouza and subsequently wrapping the cooled pieces in a wrapping sheet so as to obtain steamed Gyouza.

Further, the steamed Gyouza was fried at 175° C. for 2 minutes with a vegetable oil (corn salad oil) so as to obtain Agegyouza (fried Gyouza).

### Examples 15 and 16

Water in an amount of 340 g, to which 1000 g of wheat flour, 10 g of salt (sodium chloride) and 5 g of each compound to be tested were added as shown in Table 5 and stirred, were charged to a mixer and kneaded for 12 minutes so as to obtain dough for wrapping Gyouza.

The dough thus obtained was stretched using rollers by the ordinary method so as to obtain a dough sheet having a thickness of 0.70 mm and, then, the dough sheet was cut out using a molding die (80 mm×88 mm φ) so as to obtain wrapping sheet of Gyouza.

In the next step, the stuffing of Gyouza were prepared by kneading a mixture consisting of 700 g of minced pork, 1000 g of cabbage cut into tiny pieces each having a width of 5 mm, 20 g of cut leek pieces each having a width of 5 mm, and seasonings consisting of 18 g of salt (sodium chloride), 2 g of pepper, 22 g of grated ginger, 14 g of grated garlic, 24 g of soy sauce, and 34 g of sesame oil. The mixture noted above was kneaded in a mixer for 5 minutes so as to obtain the stuffing of Gyouza.

The stuffing thus obtained was divided into small pieces each weighing 12.5 g, and each small piece was molded with the wrapping sheet mentioned above in a molding machine of Gyouza so as to obtain uncooked piece of Gyouza. The uncooked pieces thus obtained were arrayed on an exclusive tray and steamed at 90° C. for 10 minutes, followed by cooling the steamed pieces of Gyouza and subsequently wrapping the cooled pieces in a wrapping sheet so as to obtain steamed Gyouza.

Further, the steamed Gyouza was fried at 175° C. for 2 minutes with a vegetable oil (corn salad oil) so as to obtain Agegyouza.

Table 5 shows the blending conditions of the wrapping sheet and the acrylamide content (ppb) of the fried Gyouza, which was prepared in Comparative Example 5 and Examples 15 and 16 of the present invention.

TABLE 5

| Blending condition | Comp. 5 | Inv. 15 | Inv. 16 |
|---|---|---|---|
| <Main raw material> | | | |
| Wheat flour | 1000 g | 1000 g | 1000 g |
| <Sub-raw material> | | | |
| Refined salt | 10 g | 10 g | 10 g |
| (sodium chloride) | | | |
| Calcium gluconate | — | 5 g | — |
| Ferrous gluconate | — | — | 5 g |
| Water | 340 g | 340 g | 340 g |
| Analyzed AA value | 38 | 30 | 23 |
| (ppb) | | | |

As apparent from the results shown in Table 5, the addition of calcium gluconate and ferrous gluconate to the wrapping sheet of Agegyouza allowed effective decrease in acrylamide contained therein. In other words, the use of these compounds provides a method of preparing Agegyouza with decreased acrylamide.

Examples 17 to 21 and Example 22 are examples of the present invention, in which the methods of the present invention are applied to potato chips and biscuits, respectively.

### Examples 17 to 21

### Potato Chips

Peeled potatoes sliced into small pieces each having a thickness of 1 mm were dipped for 5 minutes in an aqueous solution of 1% salt (sodium chloride) containing each of various compounds to be tested as shown in Table 6, followed by removing the aqueous solution from the sliced potatoes, and subsequently frying the sliced potatoes at 175° C. for 90 seconds with a vegetable oil so as to obtain potato chips.

Table 6 shows the amount of acrylamide (AA) contained in the obtained potato chips in a relative value based on a control. In the control, the acrylamide content was measured under the same conditions as those described above, except that the test compound was not used therein.

TABLE 6
AA amount in French frier (ratio to control)

Concentration
of solution

| Example | Test compound | 1.00% | 0.50% |
|---|---|---|---|
| 17 | Gluconic acid | 0.58 | 0.69 |
| 18 | D-Galactonic acid γ-lactone | 0.72 | — |
| 19 | Potassium gluconate | 0.83 | — |
| 20 | Sodium gluconate | 0.85 | 1.04 |
| 21 | Calcium gluconate | 0.78 | 1.12 |

As apparent from the results shown in Table 6, the amount of acrylamide contained in the potato chips can be effectively lowered in the case where the sliced potato pieces are dipped in an aqueous solution containing at least 0.5% of any of gluconic acid, D-galactonic acid γ-lactone, potassium gluconate, sodium gluconate and calcium gluconate or in an aqueous solution containing at least 1% of any of D-galactonic acid γ-lactone and other gluconates. In other words, the use of these compounds provides a method of preparing potato chips with decreased acrylamide.

### Example 22

### Biscuits

For preparing biscuit dough, 15 g of sugar and 5 g of isomerized sugar were mixed with 12.5 g of shortening, followed by adding to the mixture 15 g of an aqueous solution containing 0.25 g of each of the compounds to be tested as shown in Table 7. Then, a mixture consisting of 50 g of sieved flour and 0.5 g of sodium hydrogencarbonate was added to the mixture, followed by stretched the kneaded mixture so as to obtain biscuit dough having a thickness of 5 mm. The biscuit dough thus prepared was cooled in a refrigerator and, then, cut out with a circular molding die with a diameter of 4 cm. These circular pieces were baked at 170° C. for 22 minutes in an oven so as to obtain biscuits. Table 7 shows the amount of acrylamide (AA) contained in the biscuits thus obtained. In a control shown in Table 7, the acrylamide content was measured under the same conditions as those described above, except that the test compound was not used therein.

TABLE 7
AA amount in biscuits

| Example | Test compound | AA amount (ppb) |
|---|---|---|
| | Control | 60 |
| 22 | Gluconic acid | 50 |

As apparent from the results shown in Table 7, the amount of acrylamide contained in biscuits is efficiently decreased by the addition of gluconic acid in an amount of 0.5% to the amount of flour. In other words, the use of gluconic acid provides a method of preparing biscuits with decreased acrylamide.

Comparative Example 6 and Examples 23 to 27 given below are a Comparative Example and Examples of the present invention in which the methods of the present invention are applied to French frier. The results are shown herein later in Table 8.

A hundred g of potatoes for French frier on sale as frozen foods (¼ inch-cut, shoestrings cut) were dipped for 5 minutes in an aqueous solution containing 1% of each of various compounds to be tested as shown in Table 8, followed by removing the aqueous solution from the potatoes for 2 minutes and subsequently frying the potatoes at 180° C. for 3 minutes with a vegetable oil (corn vegetable oil) so as to obtain French frier. Comparative Example 6 was conducted in the same manner as above, except that each of the various test compounds was not used therein.

The blending conditions of the dipping solution and the acrylamide content of the French frier prepared in Comparative Example 6 and Examples 23 to 27 are shown in Table 8.

TABLE 8

| | Comp. | | Inv. | | Inv. | | Inv. | | Inv. | | Inv. | |
|---|---|---|---|---|---|---|---|---|---|---|---|---|
| | 6 | | 23 | | 24 | | 25 | | 26 | | 27 | |
| Blending | | | | | | | | | | | | |
| condition | | | | | | | | | | | | |
| of dipping | | | | | | | | | | | | |
| solution | | | | | | | | | | | | |
| Water | 500 | g | 490 | g | 495 | g | 495 | g | 495 | g | 495 | g |
| 50% Gluconic | — | | 10 | g | — | | — | | — | | — | |
| acid solution | | | | | | | | | | | | |
| Ferrous | — | | — | | 5 | g | — | | — | | — | |
| gluconate | | | | | | | | | | | | |
| Copper | — | | — | | — | | 5 | g | — | | — | |
| gluconate | | | | | | | | | | | | |
| Zinc | — | | — | | — | | — | | 5 | g | — | |
| gluconate | | | | | | | | | | | | |
| D-Galactonic | — | | — | | — | | — | | — | | 5 | g |
| acid | | | | | | | | | | | | |
| γ-lactone | | | | | | | | | | | | |
| Analyzed AA | 443 | | 334 | | 284 | | 322 | | 326 | | 374 | |
| value (ppb) | | | | | | | | | | | | |

As apparent from the results in Table 8, the dipping of potatoes into 1% solution of gluconic acid, ferrous gluconate, copper gluconate, zinc gluconate and D-galactonic acid γ-lactone allowed effective decrease in acrylamide contained therein. In other words, the use of these compounds provides a method of preparing French frier with decreased acrylamide.

### Measuring Example 1

### Model Test for Suppressing Acrylamide Formation

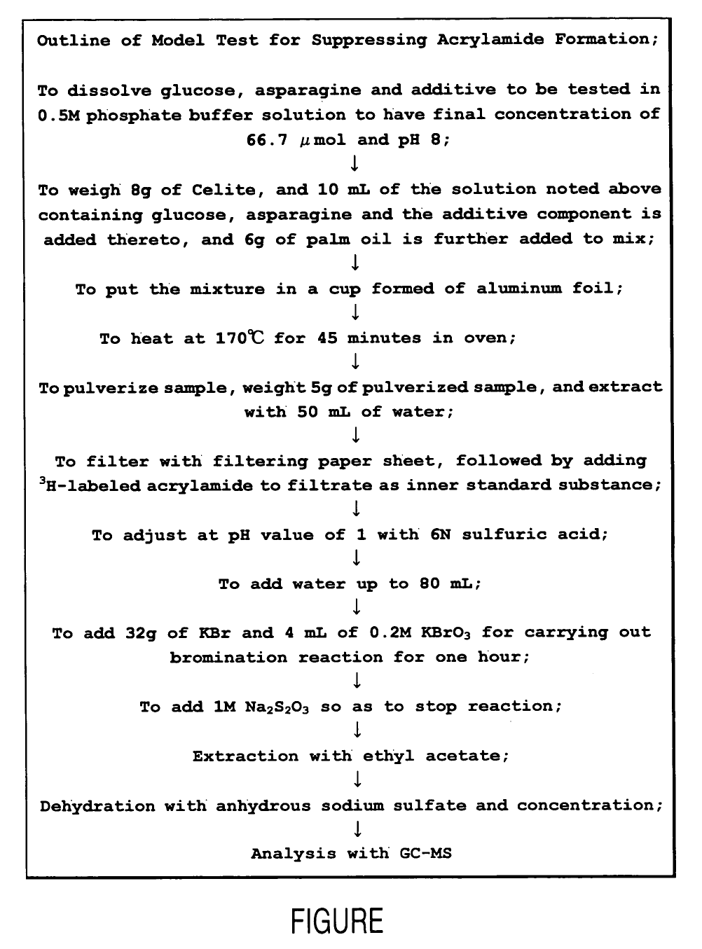

The functions of various compounds for suppressing the acrylamide formation were measured by the method outlined in FIG. 1. The method shown in FIG. 1, which has been devised by the present inventors based on the technical ideas disclosed in “Chemical Research in Toxicology 13”, pp. 517-522 (2000) and “Nature” 419, pp. 448-450 (2002) referred to previously in conjunction with the prior art, can be significantly used as a model test for estimating the function of suppressing the acrylamide formation which is attained by the compound to be tested in the food cooked under heat.

Table 9 shows the ratio by weight of the amount of generation of acrylamide for each test additive relative to a control.

TABLE 9
Results of model test for suppressing
acrylamide formation

| | Generated acrylamide amount |
|---|---|
| Tested compound | (ratio to control) |
| Gluconic acid | 0.70 |
| Sodium gluconate | 0.76 |
| Potassium gluconate | 0.54 |
| Calcium gluconate | 0.43 |
| Ferrous gluconate | 0.34 |
| Zinc gluconate | 0.55 |
| Copper gluconate | 0.14 |
| Gluconic acid δ-lactone | 0.76 |
| D-galactonic acid γ-lactone | 0.74 |

The aldonic acids and salts thereof that are effective for suppressing the acrylamide formation in the model test can be found from Table 9.

### Measuring Example 2

### Method of Measuring Acrylamide Content in Fried Noodles

(i) Extraction from Noodles

Ten g of pulverized noodle sample immediately after the frying was weighed, and a prescribed amount of a heavy hydrogen labeled acrylamide was added to the sample as an internal standard substance. As the standard addition segment, acrylamide and heavy hydrogen labeled acrylamide were added to the same amount of the noodle sample. Distilled water in an amount of 100 mL (milliliters) was added to each of these samples and, after homogenization and extraction by shaking for 5 minutes, the supernatant separated by the centrifugal operation was recovered. Then, a distilled water in an amount of 60 mL was added to the residue of the sample, followed by extraction by shaking and separation by centrifugation two times so as to obtain the separated supernatant liquid. Further, the supernatant liquid thus obtained was subjected to the suction filtration so as to obtain about 200 mL of the extracted liquid.

(ii) Bromination of Extracted Acrylamide

About 250 mL of the extracted liquid having the pH value adjusted with sulfuric acid was quantitatively separated in accordance with the measuring method of acrylamide monomer specified in “Guide Line of Test Method for Evaluating the City Water Chemicals” published in March, 2000 by the Waterworks Maintenance Section, Waterworks Environment Department of the Livelihood Bureau, the former Ministry of Health and Welfare. Then, 100 g of potassium boride was dissolved in the extracted liquid thus separated.

Further, 12.5 mL of 0.2M potassium bromate solution was added for carrying out the reaction for 60 minutes so as to achieve the bromination.

(iii) Debromination from Reaction Mixture

The free bromine was removed by adding 1M sodium thiosulfate drop-wise immediately after 60 minutes.

(iv) Extraction of Brominated Acrylamide

The total amount of the bromination reaction mixture and 25 mL of ethyl acetate were put in a separatory funnel, and the funnel was allowed to stand still after vibration for 5 minutes so as to recover the ethyl acetate layer. Then, 10 mL of ethyl acetate was added to the residual water layer, followed by recovering the ethyl acetate layer. The operations described above were carried out twice so as to obtain about 45 mL of the solvent extracted liquid in a centrifugal tube.

(v) Dehydration of Extracted Solvent

The solvent extracted liquid was centrifuged so as to remove the water layer, and 10 g of anhydrous sodium sulfate was added to the ethyl acetate layer. After the residue was allowed to stand still for 30 minutes, the residue was dehydrated and, then, filtered.

(vi) Condensation of Solvent Extracted Liquid

The solvent extracted liquid was condensed to about 5 mL by using a rotary evaporator, followed by adding ethyl acetate up to a constant volume of 10 mL, thereby obtaining a solution for examination.

(vii) Measurement of Acrylamide by GC-MS

A part of the solution for examination thus obtained was taken out, and triethylamine was added to the solution for examination. After the mixed solution was left to stand for 20 minutes, the GC-MS analysis was applied. The acrylamide content was calculated from the area ratio of the heavy hydrogen labeled acrylamide added as an internal standard substance to acrylamide.

The acrylamide contents of foods other than noodles were measured in the similar manner by appropriately changing the above method.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of preparing food to be cooked under heat or food cooked under heat, which is capable of decreasing acrylamide contained in the food after the cooking, wherein the method comprises adding to the food at least one aldonic acid or a salt thereof.

2. The method of preparing food to be cooked under heat or food cooked under heat according to claim 1, wherein the aldonic acid or the salt thereof is selected from the group consisting of gluconic acid, galactonic acid, mannonic acid, allonic acid, altronic acid, gulonic acid, idonic acid, talonic acid, lyxonic acid, xylonic acid, arabinonic acid, ribonic acid threonic acid, erythronic acid and salts thereof.

3. The method of preparing food to be cooked under heat or food cooked under heat according to claim 1, wherein the aldonic acid or the salt thereof is selected from the group consisting of gluconic acid, galactonic acid, mannonic acid, xylonic acid and salts thereof.

4. The method of preparing food to be cooked under heat or food cooked under heat according to claim 1, wherein the food contains a cereal flour and/or starch.

5. The method of preparing food to be cooked under heat or food cooked under heat according to claim 1, wherein the temperature at which the food is to be cooked or cooked under heat is not lower than 120° C.

6. The method of preparing food to be cooked under heat or food cooked under heat according to claim 1, wherein the cooking under heat is carried out by frying, stir-frying or roasting.

7. The method of preparing food to be cooked under heat or food cooked under heat according to claim 1, wherein the food is selected from the group consisting of noodles, tempura (Japanese deep-fried food), baked confectionery, fried confectionery, snacks and foods having wrapping sheet of dough made of a cereal flour or starch.

8. The method of preparing food to be cooked under heat or food cooked under heat according to claim 7, wherein the baked confectionery is biscuits, the fried confectionery is Karintou, the snacks is potato chips, and the foods having wrapping sheet of dough are selected from Agegyouza and Yakigyouza.

9. The method of preparing food to be cooked under heat or food cooked under heat according to claim 1, wherein the food is to be cooked or cooked at a temperature for a period of time which permit the amount of acrylamide to be increased after the cooking under heat, compared with the amount of acrylamide contained in the food before the cooking under heat, in the case where the food to which the aldonic acid or the salt thereof is not added, is cooked under heat.

10. The method of preparing food to be cooked under heat according to claim 1, wherein the method does not comprise final cooking of the food under heat for serving to eat to which the aldonic acid or the salt thereof is added, thereby to prepare semi-cooked food.

11. The method of preparing food cooked under heat according to claim 1, wherein the method further comprises cooking the food under heat to which the aldonic acid or the salt thereof is added, thereby to prepare the food cooked under heat.

12. Food before cooking under heat, which is prepared by the method according to claim 1, and which is capable of lowering acrylamide contained in the food after the cooking under heat.

13. Food cooked under heat, which is prepared by the method according to claim 1, in which acrylamide was lowered.
